(19) United States
(12) Patent Application Publication
(10) Pub. No.: US 2008/0028283 A1
(43) Pub. Date: Jan. 31, 2008

(54) Document production support device, methods thereof and storage medium

(75) Inventor: Shingo Iwasaki, Fujisawa-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/819,669

(22) Filed: Jun. 28, 2007

(30) Foreign Application Priority Data
Jul. 28, 2006 (JP) 2006-206980

(51) Int. Cl. G06F 15/00

(52) U.S. Cl. 715/200; 705/8

(57) ABSTRACT

A document production support devices accepts entry of instructions specifying a plurality of devices, determines an order of invoking the specified plurality of devices in accordance with attributes of the specified plurality of devices, and generates a sequential process description document invoking the plurality of devices in the determined order.

### BACKGROUND OF THE INVENTION

1. Field of the Invention

The present invention relates to document production support device, method thereof and storage medium.

2. Description of the Related Art

In the past, when producing a sequential process description document (for example WS-BPEL) reflecting contents related to completion of a single task by combining a plurality of certain processes, the document was created from scratch using a text editor. Alternatively, it was created from scratch using a dedicated editor etc. capable of easily producing a document structure, etc. corresponding to the type of the sequential process description document. Moreover, a technology for more fine-tuned specification of workflow control content has been described in Japanese Patent Laid-open No. 2005-149332.

However, under the conventional method, in a situation where a single task is completed by combining multiple processes, sequential process description documents have been produced by authors using an editor while considering the direction of the data stream between one process and another and considering the corresponding sequence of process invocation. For this reason, production of sequential process description documents has been extremely burdensome.

### SUMMARY OF THE INVENTION

Thus, it is an object of the present invention to alleviate the burden of producing sequential process description documents.

It is another object of the present invention to generate sequential process description documents that determine the order of invoking a plurality of devices and invoke the plurality of devices in that order.

According to one aspect of the present invention, a document production support device comprises: input unit adapted to input an instruction specifying a plurality of devices; determination unit adapted to determine an order of invoking the specified plurality of devices in accordance with attributes of the specified plurality of devices; and generation unit adapted to generate a sequential process description document for invoking the plurality of devices in the determined order.

According to another aspect of the present invention, a document production support device comprises: input unit adapted to input an instruction specifying a first role a first device has and a second role a second device has; determination unit adapted to determine an order of invoking the first device and the second device in accordance with the specified first role the first device has and the specified second role the second device has; and generation unit adapted to generate a sequential process description document for invoking the first device and second device in the determined order.

According to still another aspect of the present invention, a document production support method comprises the steps of: inputting an instruction specifying a plurality of devices; determining an order of invoking the specified plurality of devices in accordance with attributes of the specified plurality of devices; and generating a sequential process description document for invoking the plurality of devices in the determined order.

According to yet another aspect of the present invention, a document production support method comprises the steps of: inputting instructions specifying a first role a first device has and a second role a second device has; determining an order of invoking the first device and the second device in accordance with the specified first role the first device has and the specified second role the second device has; and generating a sequential process description document for invoking the first device and second device in the determined order.

According to still yet another aspect of the present invention, a storage medium storing a computer program for document production support, the computer program comprises the steps of: inputting an instruction specifying a plurality of devices; determining an order of invoking the specified plurality of devices in accordance with attributes of the specified plurality of devices; and generating a sequential process description document for invoking the plurality of devices in the determined order.

According to yet still another aspect of the present invention, a storage medium storing a computer program for document production support, the computer program comprising the steps of: inputting an instruction specifying a first role a first device has and a second role a second device has; determining an order of invoking the first device and second device in accordance with the specified first role the first device has and the specified second role the second device has; and generating a sequential process description document for invoking the first device and second device in the determined order.

Further features of the present invention will become apparent from the following description of exemplary embodiments (with reference to the attached drawings).

### BRIEF DESCRIPTION OF THE DRAWINGS

FIG. 1 is a diagram illustrating the configuration of a document production support device used in an embodiment of the present invention.

FIG. 2 is a diagram specifically illustrating information on the role of each device, information on the priority ranking of the roles, as well as the priority ranking of each device.

FIG. 3 is a diagram illustrating operation flow up to the point of determining the sequence of device process invocation, by showing how it would look in the window of a dedicated editor equipped with the logic of a first embodiment of the present invention.

FIG. 4 is a diagram illustrating a specific example of a pattern, in which the sequence of invocation cannot be determined based on device role information alone.

FIG. 5 is a diagram illustrating a specific example of a template for a sequential process description document produced based on information establishing an invocation sequence.

FIG. 6 is a flow chart for illustrating the flow of processing by the document production support device in the first embodiment of the present invention.

FIG. 7 is a diagram illustrating operation flow up to the point of determining the sequence of device process invocation, by showing how it would look in the window of an editor equipped with the logic of a second embodiment of the present invention.

FIG. 8 is a diagram illustrating operation flow up to the point of determining the sequence of process invocation for three devices selected by the user.

FIG. 9 is a diagram illustrating a specific example of a template for a sequential process description document produced based on information establishing an invocation sequence.

FIG. 10 is a flow chart for illustrating the flow of processing by the document production support device in the second embodiment of the present invention.

### DESCRIPTION OF THE EMBODIMENTS

Preferred embodiments according to the present invention are explained in detail below by referring to the accompanying drawings.

### Embodiment 1

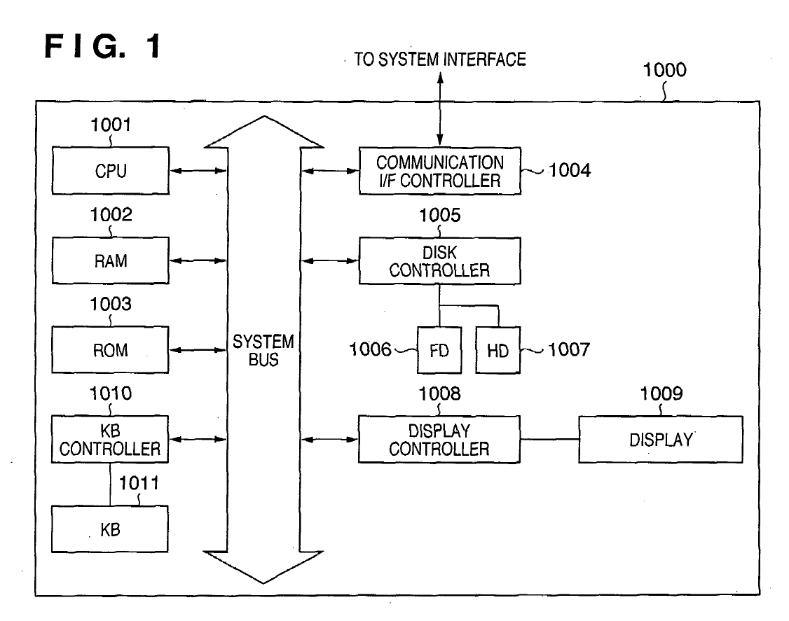

First of all, explanations are provided regarding a first embodiment of the present invention. FIG. 1 is a diagram illustrating the configuration of a document production support device used in this embodiment.

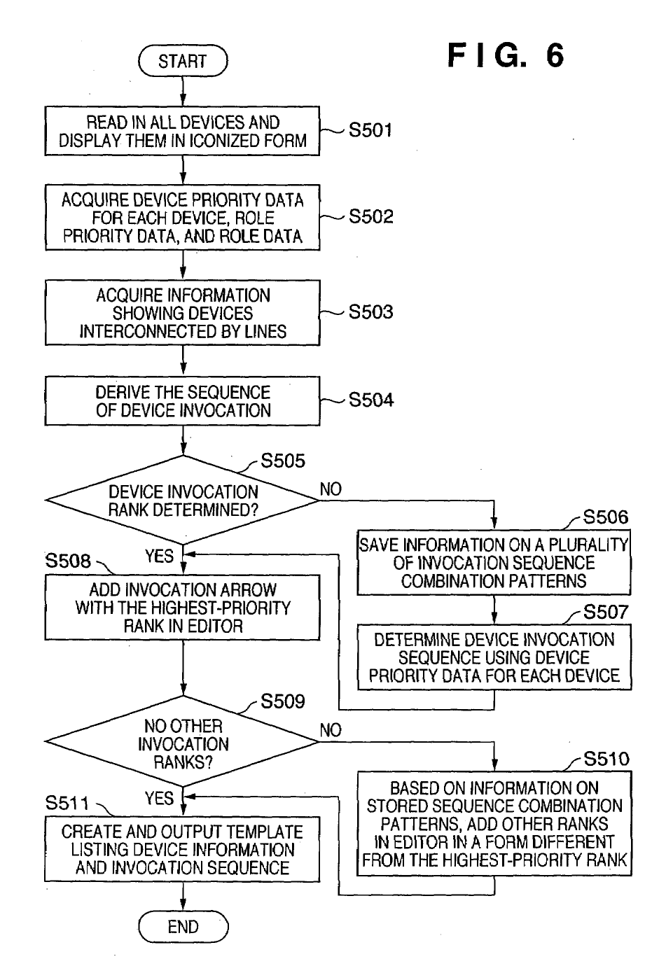

FIG. 1 is a block diagram illustrating the hardware configuration of a document production support device 1000 used in this embodiment. A CPU 1001 exercises overall control over each device and controller connected to a system bus. An Operating system program and BIOS (Basic Input/Output System), which is a program controlling the CPU 1001, are stored in a ROM 1003 or on a hard disk (HD) 1007. In addition, a program etc. performing the processing carried out by the document production support device 1000, for example, the processing illustrated in FIG. 6, is stored in the ROM 1003 or on the hard disk (HD) 1007.

It should be noted that although the HD 1007 is adapted to be arranged inside the document production support device 1000 in the example of FIG. 1, with respect to the HD 1007, configuration used in another embodiment may involve arrangement outside of the document production support device 1000. Moreover, a configuration may be used, in which a program used to carry out the processing of the present embodiment, for example, the processing illustrated in FIG. 6, is stored on a flexible disk (FD) 1006, a CD-ROM, or another computer-readable recordable medium and is supplied from such recordable media. Moreover, a configuration may be used, in which the program is supplied via the Internet or another communication medium.

A RAM 1002 operates as the main memory and work area, etc. of the CPU 1001. The CPU 1001 carries out various operations by loading software programs etc. required during process execution into the RAM 1002 and executing the software programs.

A disk controller, 1005, controls access to external memories such as the HD 1007 and FD 1006. A communication I/F controller, 1004, is connected to the Internet and LANs and controls communications with the outside via, for instance, TCP/IP.

A display controller, 1008, controls the display of images on a display, 1009.

A KB (keyboard) controller, 1010, receives operational input from a keyboard (KB) 1011 and transmits it to the CPU 1001. Although it is not shown in the figure, in addition to the keyboard 1011, a pointing device such as a mouse can also be used in the document production support device 1000 according to the present embodiment as user operating means.

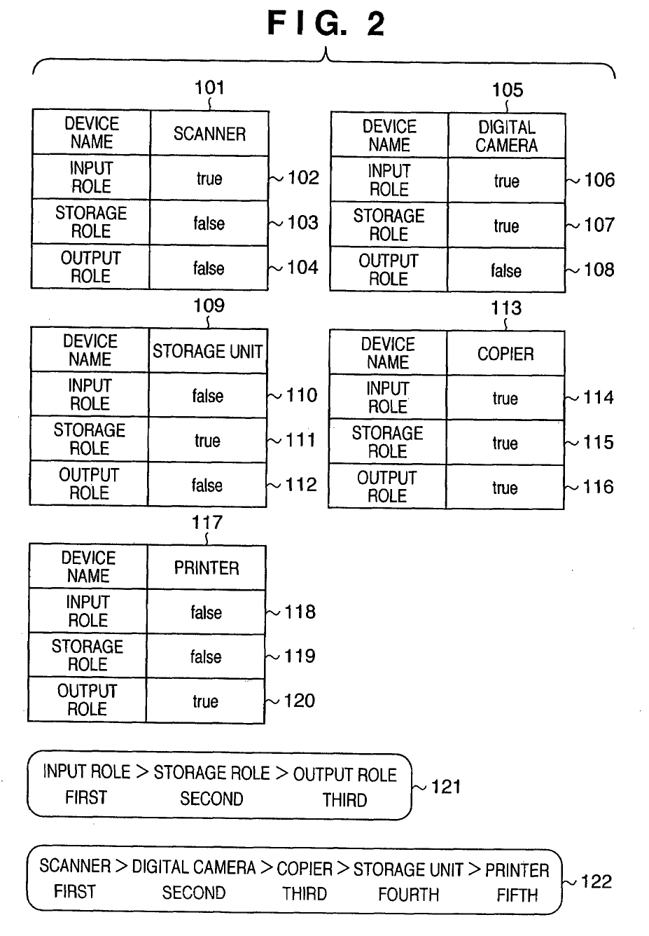

FIG. 2 specifically illustrates information concerning data on relative device priority, as well as role priority data and role data for each device used in the production of a sequential process description document. This data is stored in on the HD 1007 or another storage device.

Reference numeral 101 in FIG. 2 represents role data for a scanner. Because a scanner is a device used for inputting images drawn (printed) on paper or film into the computer, it performs an “input” role. Therefore, as illustrated at 102 in FIG. 2, the input role is set to “true” in the sense that the device performs an input role. Moreover, as illustrated at 103 and 104 in FIG. 2, the storage role and output role are set to “false” because the device performs neither a storage role nor an output role.

Reference numeral 105 in FIG. 2 represents role data for a digital camera. Because a digital camera is a device that stores image data depicting an object in the storage unit of the camera main body or on external storage media and is capable of inputting the image data into a computer, it performs a “storage” role and an “input” role. Accordingly, as illustrated at 106 and 107 in FIG. 2, the input role and storage role are set to “true” in the sense that the device performs an input role and a storage role. Moreover, as illustrated at 108 in FIG. 2, the output role is set to “false” because the device does not perform an output role.

Reference numeral 109 in FIG. 2 represents role data for a storage unit. A storage unit is a device capable of storing data and therefore performs a “storage” role. Accordingly, as illustrated at 111 in FIG. 2, the storage role is set to “true” in the sense that the device performs a storage role. As illustrated at 110 and 112 in FIG. 2, the input role and output role are set to “false” because the storage unit performs neither an input role nor an output role.

Reference numeral 113 in FIG. 2 represents role data for a copier. A copier is a device used to obtain data by scanning drawings on paper, store the scanned data in the storage unit of the copier main body, and output it by printing on paper. In this manner, a copier performs all the roles, including input, storage, and output, and therefore, as illustrated at 114-116 in FIG. 2, the input role, storage role, and output role are all set to “true”.

Reference numeral 117 in FIG. 2 represents role data for a printer. Because a printer is a device that mainly outputs computer data on paper, it performs an “output” role. Accordingly, as illustrated at 120 in FIG. 2, the output role is set to “true” in the sense that the device performs an output role. Moreover, as illustrated at 118 and 119 in FIG. 2, the input role and storage role are set to “false” because the printer performs neither an input role nor a storage role.

Reference numeral 121 in FIG. 2 represents role priority data that establishes rankings specifying which role is preferable in carrying out a process when roles are compared in terms of process execution. The sequence is such that the priority ranking of the input role is highest, with the storage role and output role following it. Namely, the rankings are as follows: the input role is in the first place, the storage role is in the second place, and the output role is in the third place.

Reference numeral 122 in FIG. 2 represents data on relative device priority that establishes rankings specifying which device is preferable in carrying out a process when devices are compared in terms of process execution. Because the priority ranking of the scanner device is highest and that of the printer is lowest, when the scanner and printer are compared, the rankings are used as a basis for determining that the process will be performed first by the scanner. Namely, the rankings are as follows: the scanner is in the first place, the digital camera in the second place, the copier in the third place, the storage unit in the fourth place, and the printer in the fifth place. These rankings, however, are merely an example, and can be set at will. This information is used below to explain the contents of processing performed in the present embodiment.

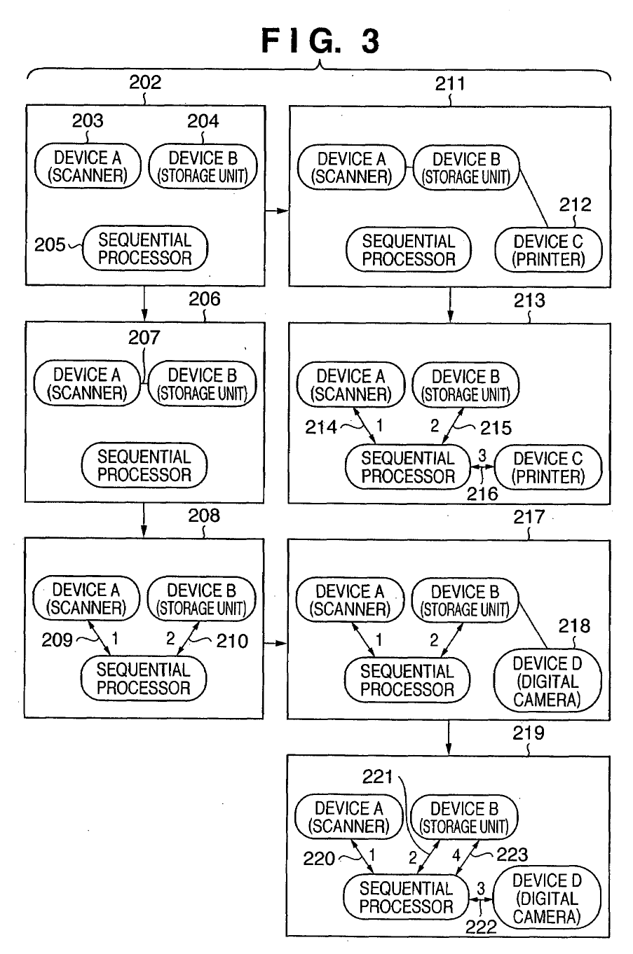

Next, the processing operations of the document production support device 1000 of the present embodiment will be explained with reference to specific examples using the exemplary screen views illustrated in FIG. 3. FIG. 3 is illustrates operation flow up to the point of determining the sequence of device process invocation, by showing how it would look in the window of a dedicated editor equipped with the logic of the present embodiment.

The reference numeral 202 in FIG. 3 designates a window, in which target devices are represented in iconized form in a state, in which information on devices used in the production of the sequential process description document, role data concerning the devices, role priority data, and data on relative device priority have already been read in.

The reference numeral 203 of FIG. 3 is an icon for Device A (scanner) and reference numeral 204 of FIG. 3 designates an icon for Device B (storage unit). The reference numeral 205 of FIG. 3 is an icon for a sequential processor. The sequential processor is a device capable of reading sequential process description documents describing the sequence of process invocation and executing their contents, with each device invoked from the sequential processor as the originator. The sequential processor can be constituted by an ordinary PC, etc.

Next, processing advances to an editor window illustrated at 206 in FIG. 3. As illustrated at 207 in FIG. 3, at such time, the CPU 1001 carries out processing that connects Device A and Device B with lines on screen in accordance with instructions inputted by the user. The CPU 1001 performs a comparison between the devices connected by lines and derives the sequence of invocation. In this case the comparison involves a scanner, that is, Device A, and a storage unit, that is, Device B, and, as illustrated in FIG. 2, the scanner performs an “input” role while the storage unit performs a “storage” role. Therefore, the basic data flow consists in storing data input via the scanner in the storage unit. The CPU 1001 refers to the role priority data illustrated at 121 in FIG. 2 and determines the sequence such that the process of the scanner, that is, Device A, is invoked first and the process of the storage unit, that is, Device B, is invoked after that.

Subsequently, processing advances to an editor window illustrated at 208 in FIG. 3. At such time, the CPU 1001 can indicate the sequence of device invocation by the sequential processor by drawing arrows bearing numbers designating the sequence of invocation, in such a manner that the derived sequence is illustrated at 209 and 210 in FIG. 3.

An editor window illustrated at 211 in FIG. 3 shows a state, wherein the Device C (printer), which is illustrated at 212 in FIG. 3, is used in addition to the devices illustrated at 202 in FIG. 3, and, in accordance with the instructions inputted by the user, Device A is connected by a line to Device B and Device B is connected by a line to Device C.

The CPU 1001 derives the sequence of invocation by comparing the three devices. The scanner, that is, Device A, performs an “input” role, the storage unit, that is, Device B, performs a “storage” role, and the printer, that is, Device C, performs an “output” role. Therefore, the basic data flow consists in storing data inputted via the scanner in the storage unit and outputting the saved data using the printer. The CPU 1001 refers to the role priority data illustrated at 121 in FIG. 2 and determines the sequence such that the scanner, that is, Device A, is invoked first, and the storage unit, that is, Device B, and then the printer, that is, Device C, are invoked thereafter.

Subsequently, processing advances to an editor window illustrated at 213 in FIG. 3. At such time, the CPU 1001 can indicate the sequence of device invocation by the sequential processor by drawing arrows bearing numbers designating the sequence of invocation, in such a manner that the derived sequence is illustrated at 214, 215, and 216 in FIG. 3.

An editor window illustrated at 217 in FIG. 3 shows a state, wherein a digital camera, that is, Device D, which is designated as 218 in FIG. 3, is added and connected to Device B by a line in accordance with user instructions in a state, in which the sequence of invocation has already been determined as illustrated at 208 in FIG. 3. In such a case, the CPU 1001 derives the ordering of Device B and Device D, because the sequence of invocation of Device A and Device B has already been determined.

As illustrated in FIG. 2, the storage unit, that is, Device B, performs a “storage” role, and the digital camera, that is, Device D, performs both “input” and “storage” roles. If the two are compared, both perform the same role of “storage”, but since line connections are not used for items performing the same role, the CPU 1001 determines that the digital cameral plays an “input” role and the storage unit a “storage” role. Therefore, the basic data flow consists in storing data input via the digital camera in the storage unit. The CPU 1001 refers to the role priority data illustrated at 121 in FIG. 2 and determines the sequence such that the digital camera, that is, Device D, is invoked first and the storage unit, that is, Device B, is invoked next.

Subsequently, processing advances to an editor window illustrated at 219 in FIG. 3. The CPU 1001 draws arrows bearing numbers indicating the sequence of invocation, in such a manner that the derived sequence is illustrated at 220 to 223 in FIG. 3. This makes it possible to illustrate the sequence, in which the sequential processor invokes the devices. Because here the sequence of invocation of Device A and Device B has been set, the process of invoking Device D is carried out third, and Device B is invoked fourth once again.

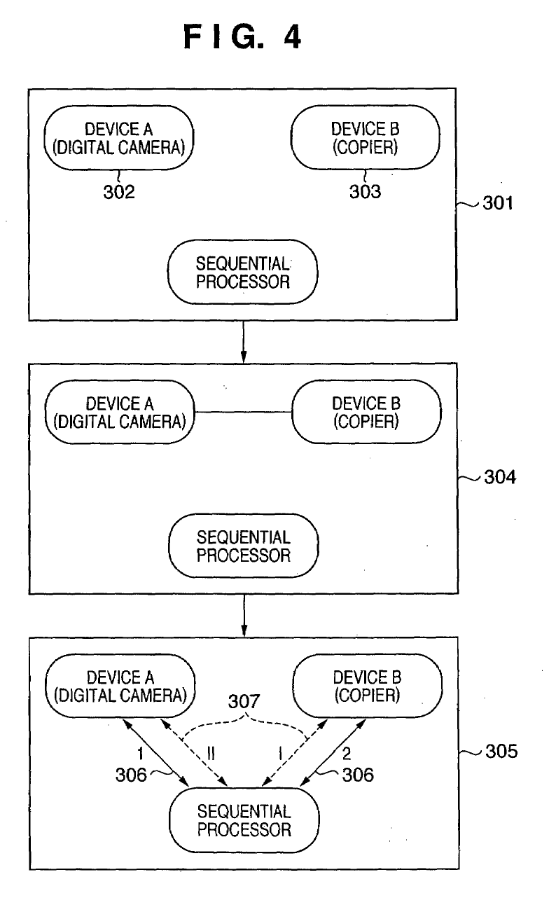

Here, a specific example of a pattern, in which the sequence of invocation cannot be determined based on device role information alone, is illustrated in FIG. 4.

The reference numeral 301 in FIG. 4 designates a window, in which target devices are represented in iconized form in a situation, where information on devices used in the production of the sequential process description document, role data concerning the devices, role priority data, and data on relative device priority have already been read in. The reference numeral 302 of FIG. 4 is an icon for Device A (digital camera) and reference numeral 303 of FIG. 4 designates an icon for Device B (copier).

Subsequently, processing advances to an editor window illustrated at 304 in FIG. 4. In accordance with the instructions inputted by the user, Device A and Device B are connected by a line on screen. In this case, the digital camera, that is, Device A, has “input” and “storage” roles, and the copier, that is, Device B, has three roles, that is, “input”, “storage”, and “output”. There may be, for instance, invocation sequence patterns involving “output” or “storage” of data input via the digital camera to the copier, and patterns, in which data input via the copier is stored in the storage unit of the digital camera, may be considered as well. Therefore, in this example, the sequence of invocation cannot be determined using device roles alone. Thus, in such a case, the invocation sequence is derived with account taken of the data on relative device priority illustrated at 122 in FIG. 2.

In accordance with the data on relative device priority illustrated at 122 in FIG. 2, when the digital camera is compared with the copier, the priority ranking of the digital camera is higher. Hence, the CPU 1001 determines the sequence in such a manner that the digital camera is invoked first to output or store data input via the digital camera in the copier, and the copier is invoked after that. However, when several invocation sequences are considered, other invocation sequences are stored as well.

Subsequently, processing advances to an editor window illustrated at 305 in FIG. 4. The CPU 1001 draws arrows bearing numbers indicating the sequence of invocation, in such a manner that the derived sequence is illustrated at 306 in FIG. 4. This makes it possible to illustrate the sequence, in which the sequential processor invokes the devices. In addition, when there is another invocation sequence, as illustrated at 307 in FIG. 4, the invocation sequence pattern is indicated using dashed line arrows and Roman numerals, thereby setting it apart and indicating that this pattern is of a lower priority rank than the invocation pattern illustrated at 306 in FIG. 4.

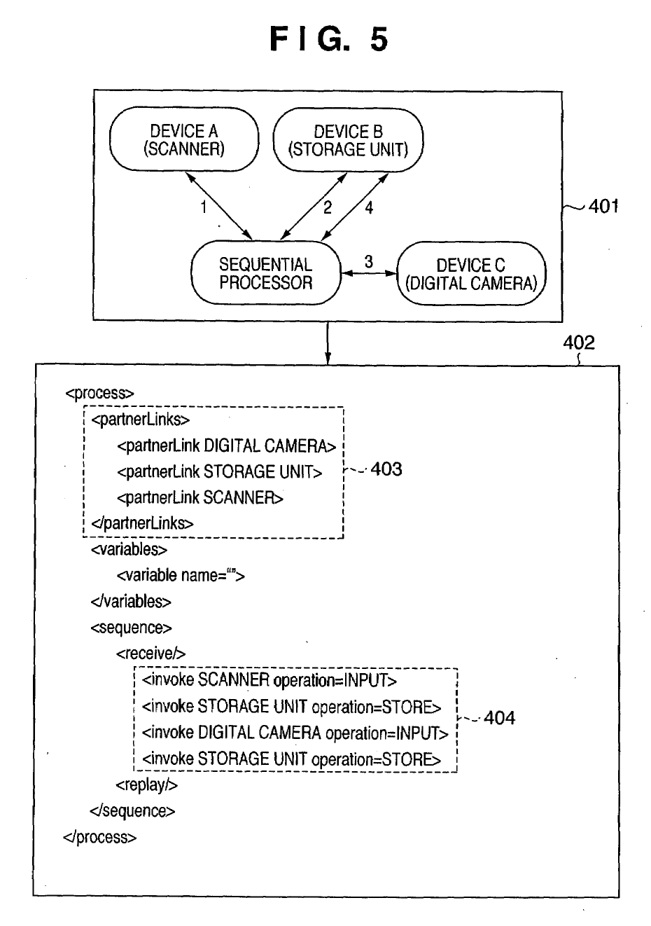

FIG. 5 is a diagram illustrating a specific example of template data for a sequential process description document produced based on information establishing an invocation sequence.

Reference numeral 401 in FIG. 5 designates an editor window produced when an invocation sequence is determined in 219 in FIG. 3, and its contents, in the form of a template for a sequential process description document, are illustrated at 402 in FIG. 5. In FIG. 5, 402 shows a specific example produced in accordance with the WS-BPEL document format.

Information that relates to the roles etc. of the devices is set up in 403 of FIG. 5 and the sequence of device invocation is set up in 404 of FIG. 5. In this case, an “invoke” tag is the element that invokes the devices, and because the devices are called from the top according to the description, the sequence of invocation is scanner, storage unit, digital camera, and storage unit. Because a template including the contents of the invocation sequence determined, for instance, as illustrated at 401 in FIG. 5, is automatically generated in accordance with the sequence, all the CPU 1001 needs to be able to complete the sequential process description document is for a human to supply the remaining necessary information.

FIG. 6 is a flow chart illustrating operation flow summarizing processing by the document production support device 1000 up to that point in the present embodiment.

First of all, the CPU 1001 reads all the user-specified device-related information, represents it in iconized form and displays it in the editor window (Step S501). It should be noted that the user specifies the devices from a list (not shown) displayed on the display 109 using the keyboard 1011 or a pointing device. The device-related information is stored on the HD 1007 or another storage device.

Subsequently, the CPU 1001 acquires role data for the respective devices, role priority data, and data on relative device priority (illustrated in FIG. 2) from the HD 1007 or another storage device (Step S502).

The CPU 1001 then acquires information describing devices interconnected by lines in the editor window in accordance with instructions inputted by the user (Step S503). It should be noted that the user connects the devices displayed on the display 109 by lines using a pointing device.

The CPU 1001 then derives the sequence of device invocation by referring to the role data of the devices connected by the lines to determine the respective roles and using the role priority data (Step S504).

The CPU 1001 then makes a determination as to whether the sequence of device invocation has been successfully determined (Step S505). When the invocation sequence patterns that can be determined are not limited to a single pattern, as explained, for instance, in FIG. 4, the CPU 1001 stores information on multiple contemplated invocation sequence patterns in the RAM 1002 (Step S506).

The CPU 1001 then carries out further prioritization among the multiple invocation sequence patterns using the data on relative device priority acquired in Step S502 and stores the invocation order patterns in the RAM 1002 (Step S507).

The CPU 1001 then draws an invocation arrow that has the highest-priority ranking assigned thereto (Step S508). It should be noted that if a single invocation sequence pattern can be determined during the discrimination process of Step S505, the process of Step S508 is executed directly without executing Step S506 or Step S507. Namely, the process of Step S508 is executed directly if only one invocation sequence pattern can be determined using the role priority data.

The CPU 1001 then makes a determination as to whether there are invocation sequence patterns with other than the highest-priority ranking (Step S509). If there are invocation sequence patterns with other than the highest-priority ranking, information on other invocation sequence patterns saved in Step S506 is used to draw invocation arrows in a shape different from the arrows added in Step S508 (Step S510). Arrows of a type different from 306 of FIG. 3 are drawn here, as illustrated, for instance, at 307 of FIG. 4.

The CPU 1001 then produces and outputs a template for a sequential process description document summarizing the device role information, etc. and the sequence of device invocation established so far in a form that allows for it to be read and executed by the sequential processor (Step S511). If there are multiple device invocation sequence patterns, it produces templates corresponding thereto and outputs them. However, it outputs them in such a form that it is clear that the sequence determined in Step S508 is the highest-priority invocation sequence pattern. It should be noted that if there are no invocation sequence patterns with other than the highest priority, processing advances from Step S509 to Step S511 without executing the process of Step S510.

As mentioned above, in the present embodiment, the sequence of device invocation can be properly determined using the device role information etc. Providing an editor etc. having this logic installed therein makes it possible to automatically produce template data for sequential process description documents that previously had to be manually produced by a human from scratch. Accordingly, the burden of producing sequential process description documents can be alleviated.

### Embodiment 2

A second embodiment of the present invention is explained next. While the first embodiment illustrated a case, in which only icons of the devices were displayed in the editor window and devices were connected directly using lines, the present embodiment illustrates a case, in which even information on the roles of the devices is represented in iconized form and these roles are interconnected by lines.

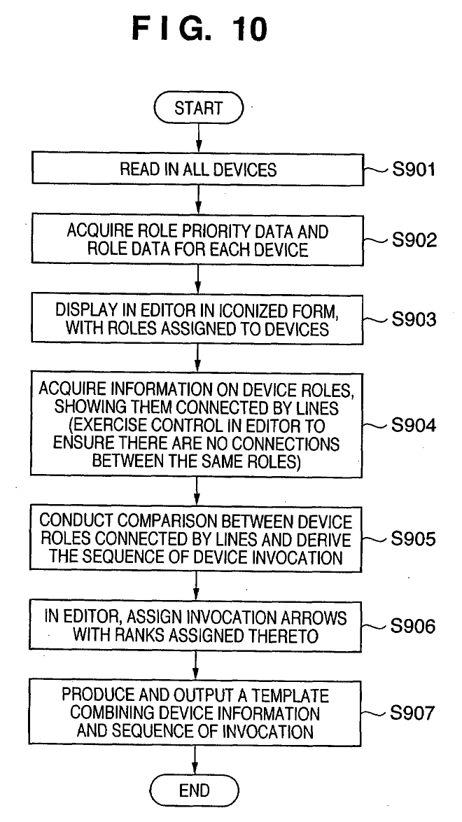

It should be noted that since the configuration of the document production support device according to the present embodiment is the same as the configuration illustrated in FIG. 1, the explanations below are provided using the numerals of FIG. 1. A process illustrated, for instance, in FIG. 10, is executed a result of the processing program of the present embodiment hereinafter explained being stored in the ROM 1003 or HD 1007, read into the RAM 1002, if necessary, and executed by the CPU 1001.

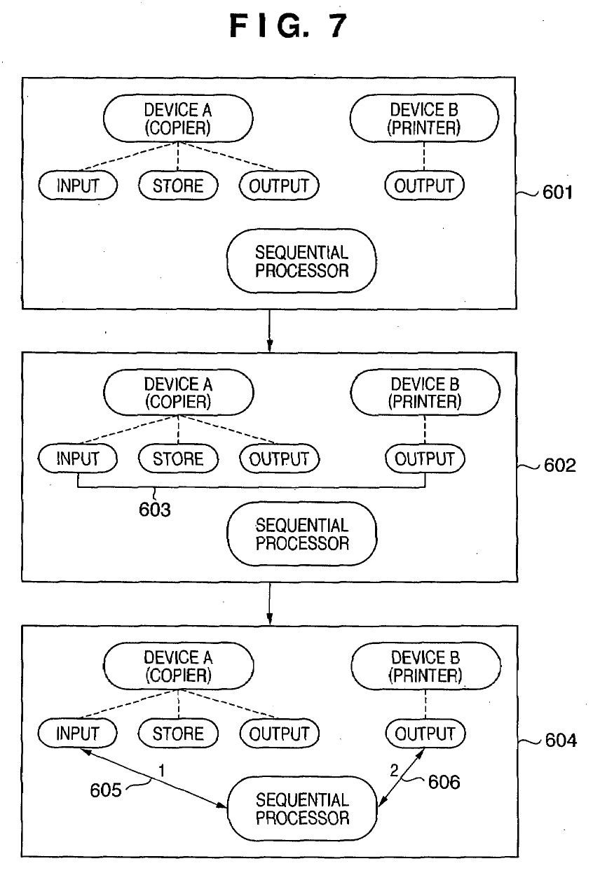

FIG. 7 is illustrates operation flow up to the point of determining the sequence of device process invocation, by showing how it would look in the window of a dedicated editor equipped with the logic of the present embodiment.

In FIG. 7, reference numeral 601 is a screen that displays, in iconized form, the target devices and the role of each device. The state represented here is one, in which information on the target devices used in the production of the sequential process description document, role data concerning the devices, role priority data, and data on relative device priority have already been read in. A copier icon for Device A and a printer icon for Device B, as well as icons indicating their respective roles, are also displayed on screen. The copier performs the “input”, “storage”, and “output” roles, and the printer performs the “output” role. The icons showing these roles are displayed based on role data illustrated at 101, 105, 109, 113, and 117 of FIG. 2.

Subsequently, processing advances to an editor window illustrated at 602 in FIG. 7. The CPU 1001, in accordance with the instructions inputted by the user, connects the “input” role of Device A and “output” role of Device B with a line, as illustrated at 603 in FIG. 7.

The CPU 1001 then compares the “input” role and the “output” role. In the data stream, data inputted via the copier is outputted to the printer. The CPU 1001 refers to the role priority data illustrated at 121 in FIG. 2 and determines the sequence such that the copier, that is, Device A, is invoked first and the printer, that is, Device B, is invoked thereafter.

Subsequently, processing advances to an editor window illustrated at 604 in FIG. 7. The CPU 1001 draws arrows bearing numbers indicating the sequence of invocation, in such a manner that the derived sequence is illustrated at 605 to 606 in FIG. 7. This makes it possible to illustrate the sequence, in which the sequential processor invokes the devices.

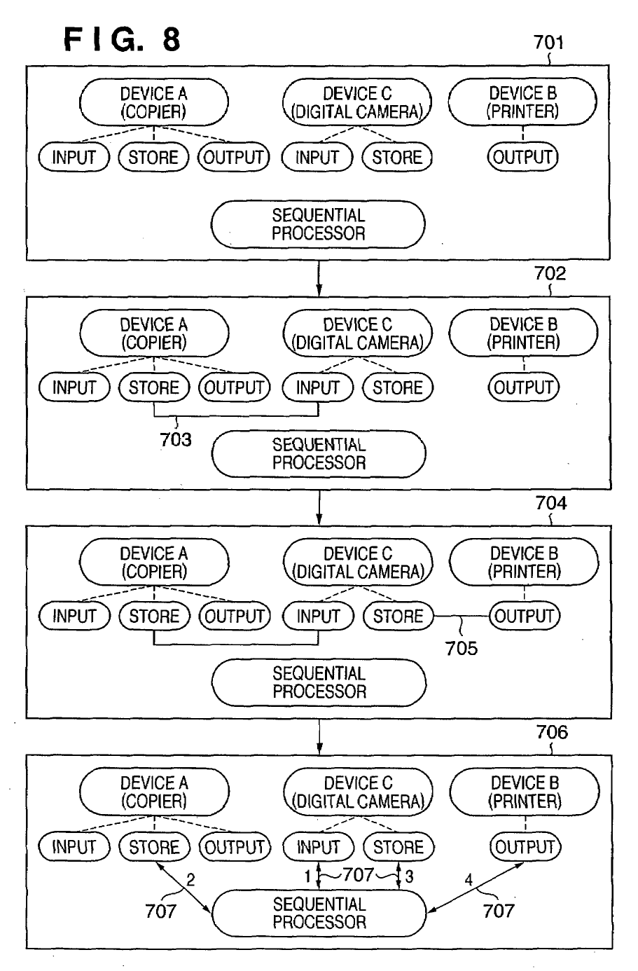

FIG. 8 is a diagram illustrating operation flow up to the point of determining the sequence of process invocation for three devices selected by the user.

A copier icon for Device A, a printer icon for Device B, and a digital camera icon for Device C, as well as icons indicating their respective roles, are also displayed in 701 of FIG. 8.

Subsequently, processing advances to an editor window illustrated in 702 of FIG. 8. At such time, the CPU 1001, in accordance with the instructions inputted by the user, connects the “storage” of Device A with the “output” of Device C with a line, as illustrated at 703 in FIG. 8.

Subsequently, processing advances to an editor window illustrated at 704 in FIG. 8. At such time, the CPU 1001, in accordance with the instructions inputted by the user, connects the “storage” of Device C with the “output” of Device B with a line, as illustrated at 705 in FIG. 8. When multiple lines are used for making connections in this manner, the sequence of device invocation is also determined by the sequence of line connections.

In the data stream, data inputted via the digital camera is stored in the copier, and data stored in the digital camera is outputted via the printer. First of all, the CPU 1001 refers to the role priority data illustrated at 121 in FIG. 2 and determines the sequence in such a manner that, in accordance with the line illustrated at 703 of FIG. 8, the digital camera, that is, Device C, is called first, and the copier, that is, Device A, is called after that. After that, the CPU 1001 determines the sequence in such a manner that, in accordance with the line illustrated at 705 in FIG. 8, it again invokes the digital camera, that is, Device C, and then, finally, invokes the printer, that is, Device B.

Subsequently, processing advances to an editor window illustrated at 706 in FIG. 8. The CPU 1001 draws arrows bearing numbers indicating the sequence of invocation, in such a manner that the derived sequence is illustrated at 707 in FIG. 8. This makes it possible to illustrate the sequence, in which the sequential processor invokes the devices.

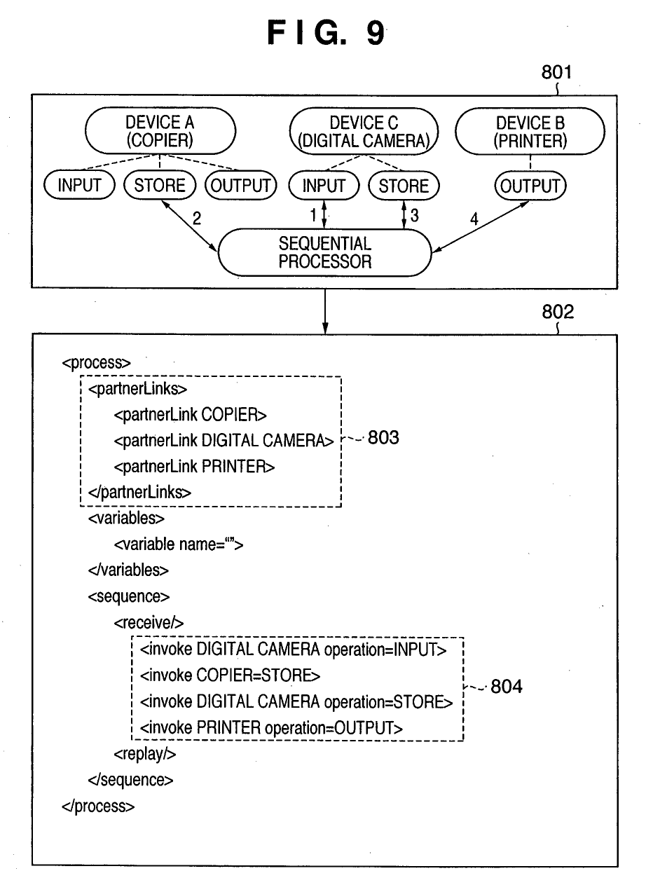

FIG. 9 is a diagram illustrating a specific example of template data for a sequential process description document produced based on information establishing an invocation sequence.

Reference numeral 801 in FIG. 9 designates an editor window produced when an invocation sequence is determined in 706 of FIG. 8, and its contents, in the form of a template for a sequential process description document, are illustrated at 802 in FIG. 9. In the present embodiment, it shows a specific example produced in accordance with the WS-BPEL document format.

Information that relates to the roles etc. of the devices is set up in 803 of FIG. 9 and the sequence of device invocation is set up in 804 of FIG. 9. In this case, an “invoke” tag is the element that invokes the devices, and because the devices are called from the top according to the description, the sequence of invocation is digital camera, copier, digital camera, and printer. Because the CPU 1001 automatically generates a template including the contents of the invocation sequence determined, for instance, as illustrated at 801 in FIG. 9, in accordance with the sequence, all that is necessary to be able to complete the sequential process description document is for a human to supply the remaining necessary information.

FIG. 10 is a flow chart for illustrating operation flow summarizing processing by the document production support device 1000 up to that point in the present embodiment.

First of all, the CPU 1001 reads all the user-specified device-related information (Step S901). It should be noted that the user specifies the devices from a list (not shown) displayed on the display 109 using the keyboard 1011 or a pointing device. The device-related information is stored on the HD 1007 or another storage device.

Subsequently, the CPU 1001 acquires role data for the respective devices and role priority data from the HD 1007 or another storage device (Step S902).

Subsequently, based on information related to the respective devices and role data for the respective devices, the CPU 1001 displays them in the editor window in a form wherein icons designating the roles of the devices are added to icons designating the devices (Step S903).

The CPU 1001 then acquires information describing devices interconnected by lines in the editor window in accordance with the instructions inputted by the user (Step S904). However, control is exercised to avoid links between the same roles. At such time, when multiple lines are used for making connections, information on the order, in which the lines are used for making connections, is retained as well. It should be noted that the user connects the devices displayed on the display 109 using a pointing device.

The CPU 1001 then derives the sequence of device invocation by referring to the role priority data and comparing the roles of the devices connected by the lines (Step S905). Here, when the information on the order of line connections is acquired, comparison starts with the roles firstly connected by a line, deriving the sequence of device invocation therefrom. Such processing can be executed in the above-described first embodiment as well.

Subsequently, the CPU 1001 displays invocation arrows having the invocation sequence derived in Step S905 assigned thereto in the editor window (Step S906).

The CPU 1001 then produces and outputs a template for a sequential process description document summarizing the device role information, etc. and the sequence of device invocation established so far in a form that allows for it to be read and executed by the sequential processor (Step S907).

While production of sequential process description documents has required obtaining the sequence of process invocation etc. from the direction of data flow from scratch, the present embodiment makes it possible to produce template data for sequential process description documents in a form, wherein the sequence of process invocation has already been determined. Accordingly, the burden of producing sequential process description documents can be alleviated because a sequential process description document can be completed simply by adding the remaining necessary data.

Moreover, the object of the present invention is also achieved if a storage medium containing a record of the program code of software implementing the functionality of the above-described embodiments is supplied to a system or apparatus and the computer of the system etc. reads the program code from the storage medium and executes it.

In such a case, the program code read from the storage medium implements the functionality of the above-described embodiments and thus the program code itself, as well as the storage medium, on which the program code is stored, form part of the present invention.

Flexible disks, hard disks, optical disks, magneto-optical disks, CD-ROMs, CD-Rs, magnetic tape, nonvolatile memory cards, ROM, etc. can be utilized as the storage media used to supply the program code.

Moreover, this includes cases, in which an OS etc. running on a computer partially or entirely executes actual processing based on the instructions of the program code read by the computer and the functionality of the above-described embodiments is implemented by such processing.

Furthermore, this includes cases, in which the program code read from the storage media is written to memory provided in an expansion unit connected to a computer, whereupon the CPU etc. carries out actual processing based on the instructions of the program code, thereby implementing the functionality of the above-described embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-206980, filed Jul. 28, 2006, which is hereby incorporated by reference herein in its entirety.

What is claimed is:

1. A document production support device comprising:
input unit adapted to input an instruction specifying a plurality of devices;
determination unit adapted to determine an order of invoking the specified plurality of devices in accordance with attributes of the specified plurality of devices; and
generation unit adapted to generate a sequential process description document for invoking the plurality of devices in the determined order.

2. The device according to claim 1, wherein the determination unit determines the order of invoking the specified plurality of devices in accordance with roles of the specified plurality of devices.

3. The device according to claim 1, wherein the determination unit has storage unit-adapted to store data used for determining the order of invoking the specified plurality of devices when the order of invocation according to the roles of the specified plurality of devices is indefinite.

4. The device according to claim 1, wherein the determination unit determines a plurality of orders of invoking the specified plurality of devices in accordance with a plurality of roles that one of the specified plurality of devices has.

5. A document production support device comprising:
input unit adapted to input an instruction specifying a first role a first device has and a second role a second device has;
determination unit adapted to determine an order of invoking the first device and the second device in accordance with the specified first role the first device has and the specified second role the second device has; and
generation unit adapted to generate a sequential process description document for invoking the first device and second device in the determined order.

6. A document production support method comprising the steps of:
inputting an instruction specifying a plurality of devices;
determining an order of invoking the specified plurality of devices in accordance with attributes of the specified plurality of devices; and
generating a sequential process description document for invoking the plurality of devices in the determined order.

7. The method according to claim 6, wherein the determination step involves determining the order of invoking the specified plurality of devices in accordance with roles of the specified plurality of devices.

8. The method according to claim 6, wherein the determination step involves determining the order of invoking the specified plurality of devices by referring to a memory storing data used for determining the order of invoking the specified plurality of devices when the order of invocation according to the roles of the specified plurality of devices is indefinite.

9. The method according to claim 6, wherein the determination step involves determining a plurality of orders of invoking the specified plurality of devices in accordance with a plurality of roles that one of the specified plurality of devices has.

10. A document production support method comprising the steps of:
inputting instructions specifying a first role a first device has and a second role a second device has;
determining an order of invoking the first device and the second device in accordance with the specified first role the first device has and the specified second role the second device has; and
generating a sequential process description document for invoking the first device and second device in the determined order.

11. A storage medium storing a computer program for document production support, said computer program comprising the steps of:
inputting an instruction specifying a plurality of devices;
determining an order of invoking the specified plurality of devices in accordance with attributes of the specified plurality of devices; and
generating a sequential process description document for invoking the plurality of devices in the determined order.

12. The storage medium according to claim 11, wherein the determination step involves determining the order of invoking the specified plurality of devices in accordance with roles of the specified plurality of devices.

13. The storage medium according to claim 11, wherein the determination step involves determining the order of invoking the specified plurality of devices by referring to a memory storing data used for determining the order of invoking the specified plurality of devices when the order of invocation according to the roles of the specified plurality of devices is indefinite.

14. The storage medium according to claim 11, wherein the determination step involves determining a plurality of orders of invoking the specified plurality of devices in accordance with a plurality of roles that one of the specified plurality of devices has.

15. A storage medium storing a computer program for document production support, said computer program comprising the steps of:
inputting an instruction specifying a first role a first device has and a second role a second device has;
determining an order of invoking the first device and second device in accordance with the specified first role the first device has and the specified second role the second device has; and
generating a sequential process description document for invoking the first device and second device in the determined order.
